(19) United States
(12) Patent Application Publication
(10) Pub. No.: US 2018/0322869 A1
(43) Pub. Date: Nov. 8, 2018

(54) VOICE TRANSMISSION DEVICE AND METHOD FOR EXECUTING VOICE ASSISTANT PROGRAM THEREOF

(71) Applicant: Unlimiter MFA Co., Ltd., Eden Island (SC)

(72) Inventors: Kuan-Li CHAO, Taipei (TW); Kuo-Ping YANG, Taipei (TW)

(21) Appl. No.: 15/813,235

(22) Filed: Nov. 15, 2017

(30) Foreign Application Priority Data
May 4, 2017 (TW) 106114788
Sep. 5, 2017 (TW) 106130313

(51) Int. Cl. G10L 15/22; G10L 15/28

(52) U.S. Cl. CPC G10L 15/22; G10L 2015/223; G10L 15/28

(57) ABSTRACT

A voice transmission device and a method for executing a voice assistant program thereof are disclosed. The voice transmission device is used to establish a connection with an electronic device having a first voice and a second voice assistant program. A detection module is used for detecting whether the second voice assistant program of the electronic device is activated to generate a first or a second flag. A memory module is used for storing the first or the second flag. When the memory module stores the first flag, a control switch generates a first control signal by a user's operation to allow the electronic device to execute the first voice assistant program. When the memory module stores the second flag, the control switch generates a second control signal by the user's operation to allow the electronic device to execute the second voice assistant program.

### BACKGROUND OF THE INVENTION

### 1. Field of the Invention

The present invention relates to a voice transmission device and a method for executing voice assistant program thereof, particularly to a voice transmission device and a method for executing a voice assistant program thereof which can be operated by users easily.

### 2. Description of the Related Art

With the advances in science and technology, a number of voice assistant programs, for example, Apple's Siri, Google's Google Now, Microsoft's Cortana or Amazon's Alexa, have been developed. A voice assistant program may be built in a company's operating system, such as Siri on iOS and Google Now on Android. To use other voice assistant programs, a user needs to additionally install the program. However, in the prior art, the built-in voice assistant program is usually executed first. It is not convenient to start the other voice assistant program. Specifically, a user who is using a headset but is unable to operate it may have problems in performing the desired voice assistant program.

Accordingly, it is necessary to devise a new voice transmission device and a method for executing voice program thereof to solve the problem in the prior art.

### SUMMARY OF THE INVENTION

It is a major objective of the present invention to provide a voice transmission device which has the user friendly operation effect.

It is another objective of the present invention to provide a method for executing voice program used for the voice transmission device described above.

To achieve the objectives described above, a voice transmission device in the present invention is used to establish a connection with an electronic device. The electronic device at least has a first voice assistant program and a second voice assistant program. The voice transmission device includes a microphone, a detection module, a memory module, and a control switch. The microphone is used for receiving a voice signal. The detection module is used for detecting whether a second voice assistant program of the electronic device is activated; when detecting that the second voice assistant program is not activated, a first flag is generated; when detecting that the second voice assistant program is activated, a second flag is generated. The memory module is electrically connected to the detection module for storing the first flag or the second flag. The control switch that is electrically connected to the memory module can read the memory module for user operation. When the memory module stores the first flag, the control switch generates a first control signal by a user's operation to allow the electronic device to execute the first voice assistant program for recognizing a voice signal; when the memory module stores the second flag, the control switch generates a second control signal by a user's operation to allow the electronic device to execute the second voice assistant program for recognizing a voice signal.

A method for executing voice program in the present invention includes the following steps: detecting whether a second voice assistant program of an electronic device is activated; generating a first flag when detecting that the second voice assistant program is not activated; generating a second flag when detecting that the second voice assistant program is activated; storing the first flag or the second flag; when the first flag is stored, generating a first control signal by a user's operation to allow the electronic device to execute the first voice assistant program; and when the second flag is stored, generating a second control signal by a user's operation to allow the electronic device to execute the second voice assistant program.

### BRIEF DESCRIPTION OF THE DRAWINGS

FIG. 1 is an architecture diagram showing the connection of a voice transmission device and an electronic device in the present invention; and

FIG. 2 is a flowchart showing steps of a method for executing a voice assistant program according to the present invention.

### DETAILED DESCRIPTION OF THE PREFERRED EMBODIMENT

Hereafter, the technical content of the present invention will be better understood with reference to preferred embodiments.

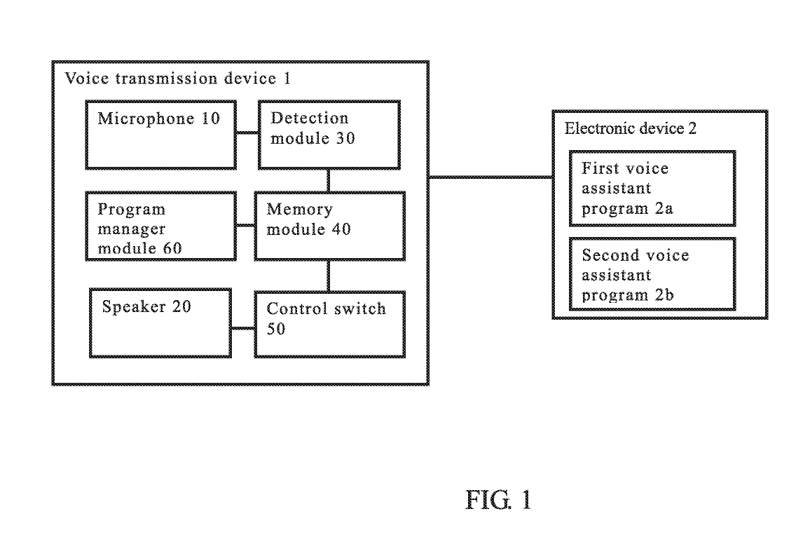

Hereafter please refer to FIG. 1, which is an architecture diagram showing the connection of a voice transmission device and an electronic device in the present invention.

A voice transmission device 1 in the present invention is used to establish a connection with an electronic device 2. In an embodiment of the present invention, the voice transmission device 1 and the electronic device 2 are connected through a Bluetooth protocol, but the voice transmission device 1 and the electronic device 2 may also be connected in other wireless or wired manners, and the present invention is not limited thereto. The electronic device 2 may be a smart phone, a tablet or notebook computer. Also, the electronic device 2 has at least a first voice assistant program 2a and a second voice assistant program 2b. The first voice assistant program 2a may be a built-in program for the operating system, e.g. Apple's Siri or Google's Google Now, and the second voice assistant program 2b, e.g. Amazon's Alexa, but the present invention is not limited to the voice assistants program listed above.

The voice transmission device 1 may be a device having both a microphone 10 and a speaker 20, for example, an earphone, wherein the speaker 20 can be a headphone, but the present invention is not limited thereto. The microphone 10 is used for receiving a user's voice signal, and the speaker 20 issues a voice signal generated by a voice assistant program. In addition, the voice transmission device 1 further includes a detection module 30, a memory module 40, and a control switch 50. The detection module 30 is used for detecting whether the voice assistant program of the electronic device 2 is activated. For example, when the voice transmission device 1 is connected to the electronic device 2, the detection module 30 actively detects whether a first voice assistant program 2a and a second voice assistant program 2b are activated. Alternatively, after the electronic device 2 is connected to the voice transmission device 1, the electronic device 2 sends the signal about whether the first voice assistant program 2a and the second voice assistant program 2b are activated to the detection module 30. However, the present invention is not limited that the detection module 30 actively or passively acquires the activation state of the first voice assistant program 2a and the second voice assistant program 2b. The first voice assistant program 2a and the second voice assistant program 2b can be activated by a user and then enter standby state, or can be set as a Terminate-and-Stay Resident (TSR) program after boot by the electronic device 2, but the present invention is not limited thereto.

Thus, when the detection module 30 detects that the second voice assistant program 2b is not activated, or the detection module 30 detects that the electronic device only activates the first voice assistant program 2a, the detection module 30 generates a first flag. When the detection module 30 detects that the second voice assistant program 2b is activated, the detection module 30 generates a second flag.

The memory module 40 is electrically connected to the detection module 30 for storing the first flag or the second flag. After the detection module 30 generates the first flag or the second flag, the flag is stored in the memory module 40. The first flag and the second flag in the memory module 40 do not exist at the same time, that is, the memory module 40 will replace the old flag with the newly received flag.

The control switch 50 is electrically connected to the memory module 40 for reading the memory module 40. It may have a physical key for the user to operate. During the operation, the control switch 50 will determine the generated control signal based on the first flag or second flag stored in the memory module 40. When the memory module 40 stores the first flag, it means that the second voice assistant program 2b has not been activated, and only the first voice assistant program 2a has been activated. Thus, the control switch 50 generates a first control signal by the user's operation to allow the electronic device 2 to execute the first voice assistant program 2a for recognizing a voice signal from a microphone 10. When the memory module 40 stores the second flag, it means that the second voice assistant program 2b has been activated. Also, the control switch 50 generates a second control signal by the user's operation to allow the electronic device 2 to directly execute the second voice assistant program 2b for recognizing a voice signal from the microphone 10. At this time, the electronic device 2 does not execute the first voice assistant program 2a.

Additionally, in an embodiment of the present invention, when the detection module 30 detects that the instruction of the executed second voice assistant program 2b is not responded by the electronic device 2 within a set time, or the electronic device 2 is not executed normally after the user's repeated operation, the first flag can be generated to be stored in the memory module 40 in place of the saved second flag. As a result, when an error occurs in the electronic device 2 and the second voice assistant program 2b is not activated normally, or the response from the electronic device 2 to the second voice assistant program 2b is not received, the electronic device 2 can directly generate the first flag to be stored in the memory module 40. This forces switching to the first voice assistant program 2a to execute and avoids waiting in vain.

Furthermore, in another embodiment of the present invention, the electronic device 2 may also include a plurality of additional second voice assistant programs 2b such that the electronic device 2 can simultaneously display the plurality of additional second voice assistant programs 2b for the user to select to start. The voice transmission device 1 can further include a program manager module 60 used to manage the plurality of second voice assistant programs 2b. When one of the second voice assistant programs 2b is activated, the detection module 30 generates the second flag similarly, and at this time, the program manager module 60 records the activated voice assistant program from the plurality of second voice assistant programs 2b, i.e. records which second voice assistant program 2b is activated. Therefore, when the control switch 50 generates the second control signal by the user's operation, the program manager module 60 causes the electronic device 2 to execute the activated voice assistant program to recognize the voice signal.

It should be noted that each module in the voice transmission device 1 may be configured as a hardware device, software program in combination with hardware device, or firmware in combination with hardware device, but the present invention is not limited in the manner described above. Additionally, the preferred embodiment of the present invention described here is only illustrative. To avoid redundancy, all the possible combinations of changes are not documented in detail. However, it shall be understood by those skilled in the art that each of the modules or elements described above may not be necessary. For the implementation of the present invention, the present invention may also contain other detailed, conventional modules or elements. Each module or component is likely to be omitted or modified depending on the needs. Other modules or elements may not necessarily exist between two of any modules.

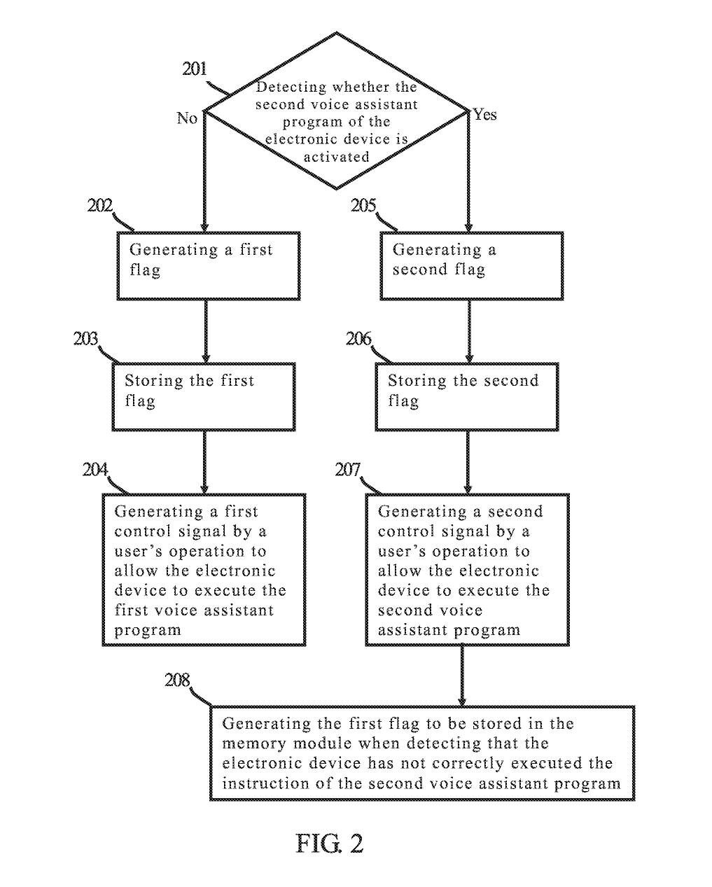

Then, please refer o FIG. 2, which is a flowchart showing steps of a method for executing a voice assistant program in the present invention. It should be noted here that although the voice transmission device 1 is described as an example of the present invention, the method for executing a voice assistant program in the present invention is not limited to the voice transmission device 1 using the same structure described above.

First of all, in Step S201: Detecting whether the second voice assistant program of the electronic device is activated.

Firstly, the detection module 30 actively or passively acquires the activation state of the second voice assistant program 2b, or acquires the state of the first voice assistant program 2a and the second voice assistant program 2b at the same time. In an embodiment of the present invention, since the first voice assistant program 2a may be a built-in program for the operating system and the second voice assistant program 2b may be an additional installation program, the first voice assistant program 2a is a Terminate-and-Stay Resident (TSR) program, and the detection module 30 can only detect the activation state of the second voice assistant program 2b.

Then, when the detection module 30 detects that the second voice assistant program 2b is not activated, in Step S202: Generating a first flag.

At this time, the detection module 30 will generate a first flag when it detects that the second voice assistant program 2b is not activated.

Next, in Step S203: Storing the first flag.

At this time, the memory module 40 is used for storing the first flag.

When the first flag is stored in the memory module 40, then, in Step S204: Generating a first control signal by a user's operation to allow the electronic device to execute the first voice assistant program.

When the first flag is stored in the memory module 40, only the first voice assistant program 2a is activated; therefore, the control switch 50 generates the first control signal by the user's operation to allow the electronic device 2 to execute the first voice assistant program 2a for recognizing a voice signal from the microphone 10.

When the second voice assistant program 2b has been activated in Step 201, perform Step S205: Generating a second flag.

When the detection module 30 detects that the second voice assistant program 2b is activated, the detection module 30 generates a second flag.

Then, in Step S206: Storing the second flag.

At this time, the memory module 40 is used for storing the second flag.

When the second flag is stored in the memory module 40, then, in Step S207: Generating a second control signal by a user's operation to allow the electronic device to execute the second voice assistant program.

When the second flag is stored in the memory module 40, it means that the second voice assistant program 2b has been activated; therefore, the control switch 50 generates the second control signal by the user's operation to allow the electronic device 2 to directly execute the second voice assistant program 2b for recognizing a voice signal from the microphone 10.

If the electronic device 2 includes a plurality of additional second voice assistant programs 2b, the user can select any of the second voice assistant programs 2b to start. At this time, the program manager module 60 records the activated voice assistant program from the plurality of second voice assistant programs 2b. When the control switch 50 generates the second control signal by the user's operation, the program manager module 60 causes the electronic device 2 to execute the activated voice assistant program to recognize the voice signal.

Further, Step 208 may be further performed: Generating the first flag to be stored in the memory module when detecting that the instruction of the second voice assistant program is not correctly executed by the electronic device.

When the detection module 30 detects that the instruction of the executed second voice assistant program 2b is not responded by the electronic device 2 within a set time, or the second voice assistant program 2b is not executed normally by the electronic device 2 after the user's repeated operation, the first flag can be generated to be stored in the memory module 40 in place of the saved second flag. This forces switching to the first voice assistant program 2a to execute and avoids waiting in vain.

It should be noted here that the method for executing a voice assistant program in the present invention is not limited to the order of the above steps. As long as the objective of the present invention can be achieved, the order of the above steps can also be changed.

In this way, the user only needs to operate the control switch 50 on the voice transmission device 1 in order to use the voice assistant program easily without the setting through the electronic device 2.

It should be noted that the preferred embodiments of the present invention described above are only illustrative. To avoid redundancy, all the possible combinations of changes are not documented in detail. However, it shall be understood by those skilled in the art that each of the modules or elements described above may not be necessary. For the implementation of the present invention, the present invention may also contain other detailed, conventional modules or elements. Each module or component is likely to be omitted or modified depending on the needs. Other modules or elements may not necessarily exist between two of any modules. All without departing from the scope of the invention are defined solely by the appended claims.

What is claimed is:

1. A voice transmission device for establishing a connection with an electronic device having at least a first voice assistant program and a second voice assistant program, the voice transmission device comprising:
a microphone, used for receiving a voice signal;
a detection module, used for detecting whether the second voice assistant program of the electronic device is activated; wherein when detecting that the second voice assistant program is not activated, a first flag is generated; when detecting that the second voice assistant program is activated, a second flag is generated;
a memory module, electrically connected to the detection module for storing the first flag or the second flag; and
a control switch, electrically connected to the memory module to read the memory module for a user's operation, wherein when the memory module stores the first flag, the control switch generates a first control signal by the user's operation to allow the electronic device to execute the first voice assistant program for recognizing the voice signal;
when the memory module stores the second flag, the control switch generates a second control signal by the user's operation to allow the electronic device to execute the second voice assistant program for recognizing the voice signal.

2. The voice transmission device as claimed in claim 1, wherein when detecting that the electronic device only activates the first voice assistant program, the first flag is generated.

3. The voice transmission device as claimed in claim 1, wherein when the detection module detects that the second voice assistant program is not correctly executed by the electronic device, the first flag is generated to be stored in the memory module.

4. The voice transmission device as claimed in claim 3, wherein the detection module determines whether the second voice assistant program is correctly executed by the electronic device within a set time or after the user's repeated operation.

5. The voice transmission device as claimed in claim 1, wherein the electronic device further comprising a plurality of second voice assistant programs; the vice transmission device further comprising a program manager module used to record one of the activated voice assistant program from the plurality of second voice assistant programs; when the second control signal being generated by the user's operation, the program manager module causing the electronic device to execute the activated voice assistant program.

6. The voice transmission device as claimed in claim 1, wherein the voice transmission device comprises a speaker.

7. The voice transmission device as claimed in claim 6, wherein the speaker is an earphone.

8. The voice transmission device as claimed in claim 1, wherein the voice transmission device and the electronic device are connected through a Bluetooth protocol.

9. A method for executing voice program used in a voice transmission device for controlling an electronic device having at least a first voice assistant program and a second voice assistant program; the method comprising the step of:
detecting whether the second voice assistant program of the electronic device is activated;
generating a first flag when detecting that the second voice assistant program is not activated;
generating a second flag when detecting that the second voice assistant program is activated;
storing the first flag or the second flag;
generating a first control signal by a user's operation to allow the electronic device to execute the first voice assistant program when the first flag is stored; and
generating a second control signal by a user's operation to allow the electronic device to execute the second voice assistant program when the second flag is stored.

10. The method for executing the voice assistant program as claimed in claim 9, further comprising the step of generating the first flag when detecting that the electronic device only activates the first voice assistant program.

11. The method for executing the voice assistant program as claimed in claim 9, further comprising the step of generating the first flag to be stored in the memory module when detecting that the electronic device has not correctly executed the second voice assistant program.

12. The method for executing the voice assistant program as claimed in claim 11, wherein the step that the electronic device has not correctly executed the second voice assistant program comprising the electronic device has not correctly executed the second voice assistant program within a set time or after the user's repeated operation.

13. The method for executing the voice assistant program as claimed in claim 9, wherein the electronic device comprising a plurality of second voice assistant programs, the method further comprising the step of recording one of the activated voice assistant programs from the plurality of second voice assistant programs when generating the second control signal by the user's operation such that the electronic device executing the activated voice assistant program.

14. The method for executing the voice assistant program as claimed in claim 9, further comprising the step of connecting through a Bluetooth protocol.
